(19) United States
(12) Patent Application Publication
(10) Pub. No.: US 2005/0242959 A1
(43) Pub. Date: Nov. 3, 2005

(54) IC tag provided with three-dimensional antenna and pallet provided with the IC tag

(75) Inventor: Toshio Watanabe, Minamiashigara-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD

(21) Appl. No.: 10/989,499

(22) Filed: Nov. 17, 2004

(30) Foreign Application Priority Data
Apr. 28, 2004 (JP) 2004-134139

(51) Int. Cl. G08B 13/14

(52) U.S. Cl. 340/572.7; 235/492; 343/893

(57) ABSTRACT

The IC tag comprises a three-dimensional antenna and an integrated circuit. The three-dimensional antenna is configured in such a manner that a plurality of planar antennas, each capable of performing emission and reception of radio waves by itself, are arranged at angles so as to be not parallel to each other. The integrated circuit is also connected to the three-dimensional antenna and performs transmission or reception of a signal via the three-dimensional antenna.

### BACKGROUND OF THE INVENTION

1. Field of the Invention

The present invention generally relates to an IC tag which is provided with an antenna and integrated circuit and which is capable of reading or writing data through radio waves, and more particularly to a technique regarding the construction of the antenna. The invention is also related to a technique of attaching the IC tag to a carrying container of an article.

2. Description of the Related Art

IC tags (which may be referred to as RFID (Radio Frequency IDentification) tags etc.) attached to a product and a carrier container, etc. have spread rapidly in recent years. The IC tag is a small and lightweight device having an integrated circuit (IC) and antenna, and is utilized for the distribution and function management, etc. of an article provided with the IC tag, by writing and reading information into and out of the integrated circuit. For example, in the field of image processing devices, such as a printer, a scanner, and a copy machine, etc., techniques have been proposed in which the IC tag is attached to the body of an image processing device, a cartridge incorporated in the image processing device and a carrying container for carrying the plural cartridges, so as to be utilized in distribution management and quality control, etc.

The IC tag performs transmission/reception (typically both) of a signal by means of a non-contact communication method utilizing radio waves to/from a reader and writer (Reader/Writer) which are externally provided. Here, the term “radio waves” is, as customarily used, taken to mean electromagnetic waves having a wave length equal to or longer than infrared, and also to indicate the disturbance of electric and magnetic fields which do not represent a clear wavelike spatial structure between the IC tag and the reader/writer. From an electromagnetic viewpoint, the communication method can be classified into a method using the principle of electrostatic coupling, a method performed using the principle of electromagnetic coupling, a method performed using the principle of electromagnetic induction, and a method performed by using microwaves. The communication range is generally dependent upon the frequency and the radio wave intensity. In the case of the passive type (the radio wave transmission performed by use of the energy of received radio waves), measures of the communication range are within about 15 cm for a 125 kHz band, within about 70 cm for a 13.56 MHz band, within about 5 m for a 900 MHz band and within about 1.5 m for a 2.45 GHz band. In the case of the active type (the radio wave transmission performed by use of the energy of a built-in battery), a measure of the communication range, which depends on the predetermined radio wave intensity, is assumed to be, for example, within about 30 m in the case of 30 MHz or about 430 MHz.

An antenna generally has directivity and presents a different transmission/reception state depending upon the relative directional relationship with a reader/writer. For this reason, in the case of communication, it is preferred that the, positional relationship between the antenna and the reader/writer (the positional and directional relationship) is suitably maintained for performing the communication. However, depending on the storage and conveyance condition of a product and a carrying container to which the IC tags are attached, it may not be possible to secure the suitable directional relationship with the reader/writer.

A related art, Japanese Patent Laid-Open Publication No. Hei 2002-321725 discloses a configuration in which a pair of extended antenna areas used in the electrostatic coupling type are adhered so as to ride over two surfaces of an article. In the case of the electrostatic coupling type, a signal is obtained based on the potential difference between a pair of antennas at the time of radio wave reception. Also, the antennas functioning as a pair, which is provided so as to ride over the two surfaces, enables one of the antennas to be easily grounded, so that the reception is improved.

### SUMMARY OF THE INVENTION

An IC tag according to the invention comprises a three-dimensional antenna formed by arranging a plurality of planar antennas at angles not parallel to each other, each planar antenna being capable of emission and reception of radio waves by itself, and an integrated circuit connected to the three-dimensional antenna for performing transmission or reception of a signal via the three-dimensional antenna.

The planar antennas consist of both of the transmission and reception antennas or either one of them. In the case where the planar antennas comprise both of the transmission and reception antennas, the planar antennas may be constituted as an antenna used in common for transmission and reception, or constituted separately with the antenna for transmission and the antenna for reception. The planar antenna, provided with suitable wiring, has a construction capable of performing emission and reception of radio waves by itself. That is, an element of the planar antenna arranged on its surface is capable of functioning as an antenna by itself. Accordingly, the planar antenna, provided with a suitable wiring, is capable of performing transmission or reception on a level that withstands practical use, apart from the problem in directivity.

In the planar antenna, the radio wave length and the communication method are not particularly restricted, and various types such as the electrostatic coupling type, the electromagnetic coupling type, the electromagnetic induction type, and the microwave type are feasible. In addition, the kinds of antennas corresponding to the above types are not particularly restricted, provided that they can be configured to be surface-shaped (planar or curved surface-shaped and may be constructed over a multiple layers). For example, a dipole antenna, a coil antenna, a patch antenna, etc. can be used. It is also possible to employ, as the shape of the antenna, various shapes such as circular and rectangular shapes, and it is also possible, for example, to employ an antenna having an antenna pattern that is a spiral pattern and the square wave pattern which can be efficiently arranged in a surface-shaped structure for avoiding multi-level crossing.

The three-dimensional antenna includes plural planar antennas. Although the number of the planar antennas is not particularly limited, two antennas, the minimum quantity required for the two dimensional construction, or three antennas, the minimum quantity required for the three dimensional construction are easily realized. Each planar antenna is arranged such that the antenna formation surfaces are arranged at angles not parallel to each other (that is, at an angle such that the directions normal to each surface are different from each other). The angles, which are slightly different from each other (for example, about 10 or 20 degrees), maybe adopted. However, in order to expand the angle and enable excellent communication, it may be preferred that the angles are set so as to mutually compensate for the dead angle in the directivity of each planner antenna. Generally, such an angle is a right angle or an angle close to a right angle (about 70 or 80 degrees). In the case where the planar antenna has a curved surface, the arrangement may be determined based on the average angle or an angle defined by the directivity. Alternatively, each planar antenna may be arranged to constitute a plural surfaces of a three-dimensional form, such as a (regular) tetrahedron and a rectangular parallelepiped, for allowing rational and stable installation. An antenna arranged in parallel with a planar antenna may also be additionally provided. However, such an antenna is not typically employed, because it causes the configuration to be redundant and it is easy for interference to occur, especially at the time of transmission.

The integrated circuit includes a construction for controlling communication and for receiving or transmitting the information. The integrated circuit may include, for example, an RF circuit for performing transmission and reception of radio waves, a ROM for incorporating a program, and a control circuit for performing control. A RAM which is a rewritable storage area may also be provided for the integrated circuit. The integrated circuit may be made in the same substrate form as at least one of the planar antennas, or may be made separately so as to be attached.

According to such a configuration, plural planar antennas, each capable of functioning by itself, are arranged in three dimensions, thereby reducing a weak spot in the directivity of each planar antenna. That is, compared with the case where a planar antenna is used as a single unit, excellent transmission and reception can be performed over a wide angular range. For this reason, communication faults can be prevented in the case where the installation angle of the antenna of the IC tag is difficult to specify due to the storage conditions and the conveying state of a product and a carrier container to which the IC tag is attached, and where the adjustment of the angular relationship with respect to the reader/writer is difficult.

The IC tag can be a type with a built-in battery as a power source (active type). As a result, the output power intensity of the IC tag can be increased, and also the antenna output power at the side of the reader/writer can be suppressed. The IC tag may be a type without a built-in battery and driven by the energy of received radio waves as a power source (passive type). In this case, the size of the IC tag can be reduced. The IC tag may also be constructed such that some components necessary for the operation of the IC tag, such as an oscillator, etc. for use in generation of a carrier wave and in demodulation at the time of reception, are externally separately provided, and connected by means of wiring for operating the IC tag. As a result, size reduction of the IC chip and IC tag can be achieved.

### BRIEF DESCRIPTION OF THE DRAWING(S)

Preferred embodiments of the present invention will be described in detailed based on the following figures, wherein:

FIG. 1. is a perspective view showing an exemplary configuration of the IC tag of an embodiment according to the invention;

FIG. 2 is a perspective view of the IC tag of FIG. 1 viewed from a different angle;

FIG. 3 is a figure showing an example of a film-like base material;

FIG. 4 is sectional view of the IC tag of FIG. 1;

FIG. 5 is a bottom view of the IC tag of FIG. 1;

FIG. 6 is a figure showing the base material form of the IC tag of FIG. 5;

FIG. 7 is a perspective view showing another exemplary configuration of the IC tag;

FIG. 8 is a figure showing an example of the antenna control configuration of the IC tag of FIG. 7;

FIG. 9 is a figure showing another example of the control configuration of the IC tag of FIG. 7;

FIG. 10 is a perspective view of a pallet to which the IC tag is attached; and

FIG. 11 is a partial sectional view of the pallet.

### DESCRIPTION OF THE PREFERRED EMBODIMENTS

A plurality of embodiments according to the invention is described with reference to the drawings below.

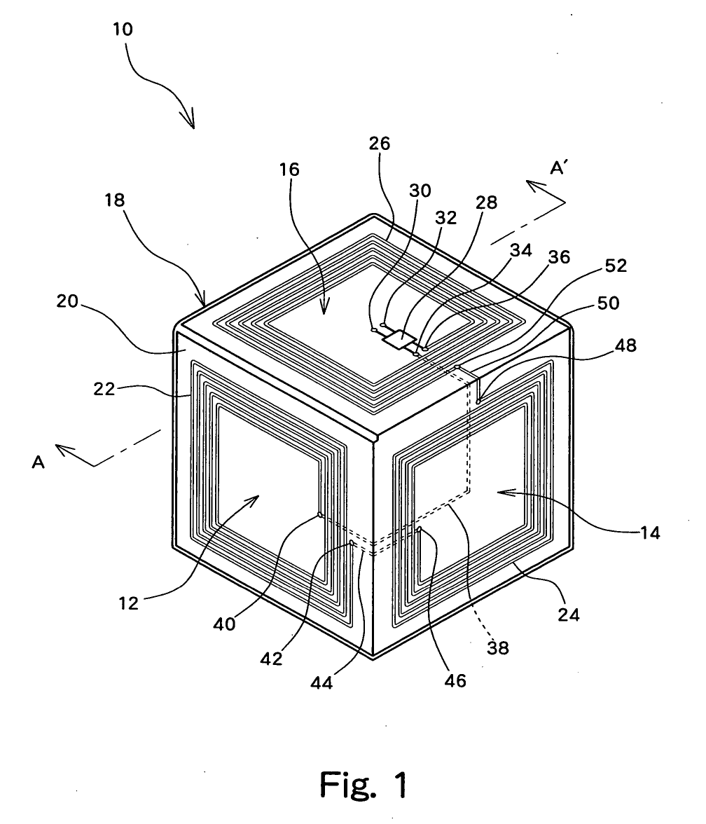

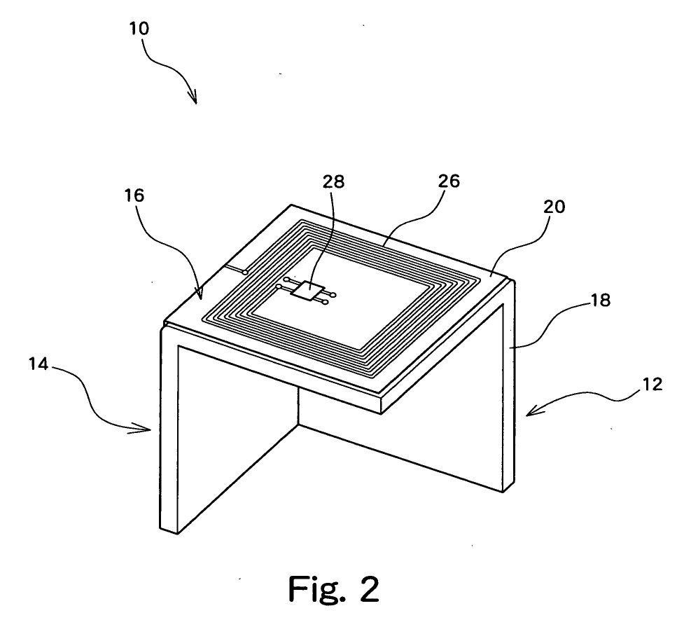

FIG. 1 is a perspective view of an exemplary embodiment of an IC tag according to the invention, viewed from a front side upper part, and FIG. 2 is a perspective view of the same IC tag viewed from a rear side upper part. The IC tag 10 is formed in such a manner that three square plates are connected to each other at their circumferential parts. That is, the IC tag is shown as a form of three surfaces taken out from a cube having three surfaces 12, 14, 16 which are orthogonal to each other. This form has a base 18 as a base material. The base 18 is processed into this form by molding of a synthetic resin. The IC tag is typically sized such that the length of one side of each surface 12, 14, 16 is about several cm (for example, 5 cm), but may be adapted to be longer or shorter depending on the size required for the antenna described below.

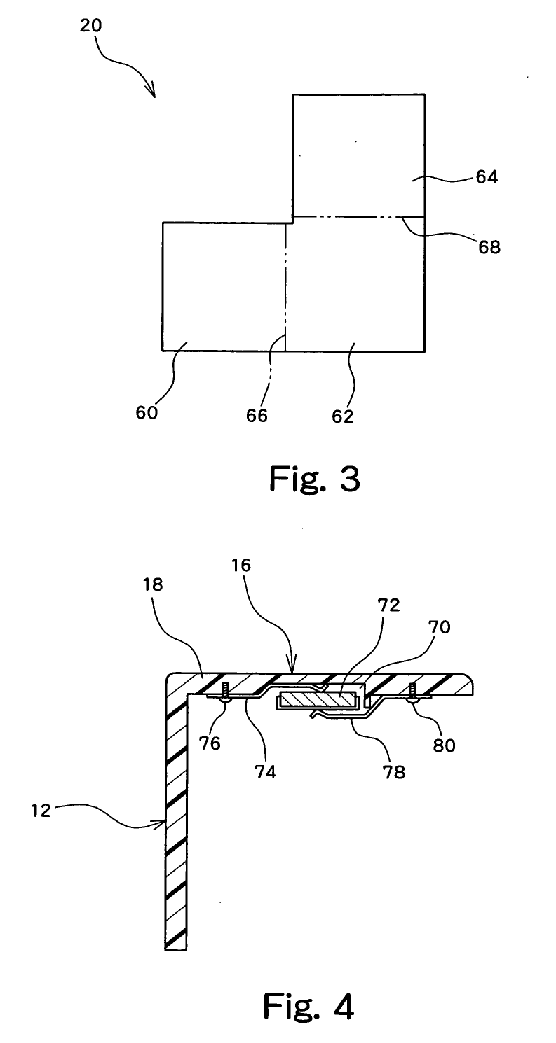

A base film 20 as a film-like base material is adhered to the surface of the base 18. FIG. 3 is a figure showing the base film 20 before the adhesion. The base film 20 is manufactured by cutting a thin film material made of a synthetic resin. The base film 20 is formed into a L-shaped form with a combination of three squares 60, 62, 64, each corresponding to each of the three surfaces 12, 14, 16 of the IC tag 10. The base film 20 is bent at bending parts 66, 68, and is adhered to the base 18.

On the base film 20, as shown in FIG. 1, metal coil antennas 22, 24, 26 are provided as the planar antennas on each surface 12, 14, 16, respectively. As shown in FIG. 1, the coil antennas 22, 24, 26, are each a coil-shaped antenna of a metal wound counterclockwise in plural turns from the inside to the outside. The coil antennas are arranged orthogonal to each other, and constitute the three-dimensional antenna as a whole.

An IC chip 28 is attached inside the coil antenna 26. In the IC chip 28, there are provided a RF circuit performing transmission and reception processing of radio waves, a ROM incorporating a program, a control circuit performing control, and a RAM storing data to be inputted and outputted. A pair of battery terminals 30, 32 and a pair of antenna terminals 34, 36 is provided issuing from the IC chip 28. The battery terminals 30, 32 are terminals for receiving electric power from the battery attached on the rear face of the base 18. Also, the antenna terminals 34, 36 are terminals to be connected to the three-dimensional antenna.

The antenna terminal 34 is connected to a terminal 40 inside the coil antenna 22 by a lead wire 38 provided on the rear face of the base film 20. A terminal 42 outside the coil antenna 22 is also connected to a terminal 46 inside the coil antenna 24 by a lead wire 44 provided on the rear face of the base film 20. Further, the terminal 48 out side the coil antenna 24 is connected to a terminal 52 outside the coil antenna 26 by a lead wire 50 provided on the front face of the base film 20. Further, the terminal inside the coil antenna 26 is connected with the other antenna terminal 36. Accordingly, the coil antennas 22, 24, 26, 36 are connected in series so as to constitute a large three-dimensional antenna.

FIG. 4 is a sectional view of the IC tag 10 taken along AA′ in FIG. 1. The cross section passes through the center of the surfaces 12, 16 among the three surfaces constituting the IC tag 10, and the base 18 is formed to be a shape obtained by rotating the L-shape by 180 degrees. On the underface of the upper side surface 16 of the base 18, a concave battery attachment part 70 is formed, where a button cell 72 is installed. On the upper side of the button cell 72, one electrode plate 74 which is arranged along the base 18, in contact with the button cell 72, is fixed to the base 18 with a bolt 76. At the bottom of the button cell 72, the other electrode plate 78 in contact with the button cell 72 is attached to the base with a bolt 80. The electrode plates 74, 78 are made of a metal, and the button cell 72 is inserted and fixed between the electrode plates by means of their elasticity.

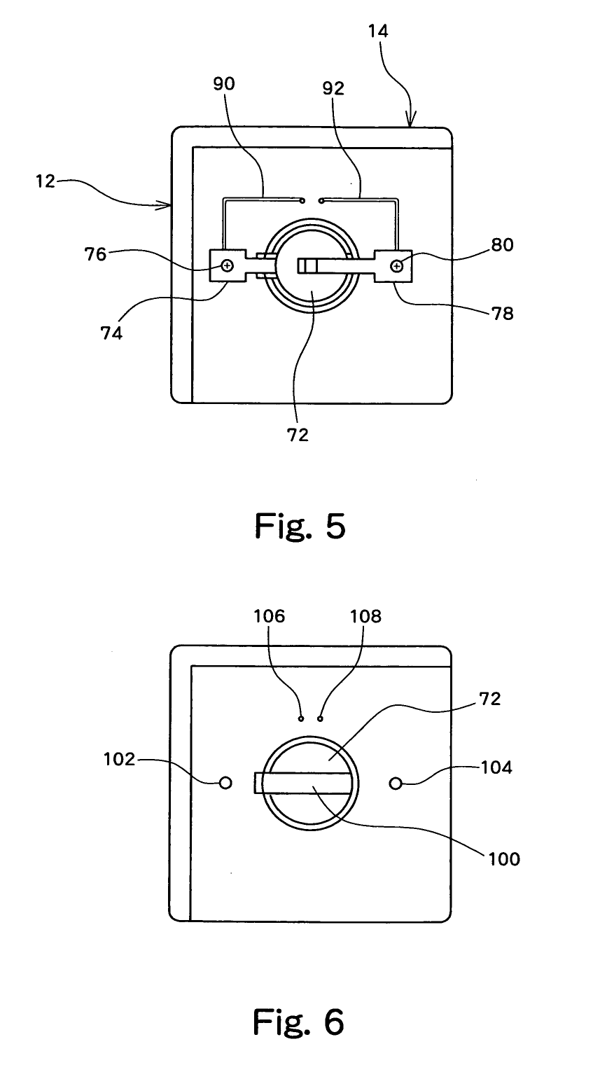

FIG. 5 is a bottom view viewed from the bottom of the IC tag 10 in FIG. 1. In the base 18 shown, the upper left part is the surface 12, the upper part is the surface 14, and remaining several parts are the faces at the rear of the surface 16. The button cell 72, as shown in FIG. 4, is fixed near the central part of the rear surface of the surface 16. In addition, to the left side of the button cell 72, the electrode plate 74 in contact with the side of the base 18 is fixed with the bolt 76. To the right side of the button cell 72, the electrode plate 78 in contact with the observer's side of the button cell 72 is fixed with the bolt 80. Lead wires 90, 92, each fixed with the bolts 76, 80, are connected to the electrode plates 74, 78, respectively. The other ends of the lead wires 90, 92 are respectively connected to the battery terminals 30, 32 of the IC chip 28 shown in FIG. 1.

FIG. 6 is a figure illustrating the base 18 viewed from the same direction as in FIG. 5. However, unlike in FIG. 5, the figure shows only the base 18 and a state before the button cell 72, the electrode plates 74, 78, the bolts 76, 80 and the lead wires 90, 92 are attached. The circular and concave battery attachment part 70, to which the button cell 72 is attached, is provided with the base 18. An electrode plate arrangement section 100, which is formed to have a still deeper concave shape so as to transverse the center of the battery attachment part 70, is further provided there. The electrode plate 74 is arranged and fixed to the electrode plate arrangement section 100 with the bolt 76 using a helical hole 102 on the left side. A helical hole 104 is also a hole for fixing the electrode plate 78 with the bolt 80. Lead wire take-out holes 106, 108 formed as two through holes, are provided above the battery attachment part 70. The lead wires 90 and 92 are led through the lead wire take-out hole 106, 108 for effecting the connection between the electrode plate 74 and the battery terminal 30, and the connection between the electrode plate 78 and the battery terminal 32.

Next, the operation of the IC tag 10 is described. There are various applications of the IC tag 10, and for example, the IC tag attached to a product manufactured in a plant can be applied widely, for example, to management at the distribution stage, information management at the time of utilization by the user, management at the recycle stage, etc. In the distribution stage etc., the IC tag 10 may be attached to the carrying container, such as a pallet and a container for use in conveying a product. Since the IC tag 10 has a three-dimensional form, it is in particular effectively fixed to a product and a carrying container in accordance with their three-dimensional form. That is, the two or three surfaces inside or outside the IC tag 10 fixed in contact with an article makes it possible to provide a stable and robust attachment.

The IC tag 10 exhibits its function by communicating with the external reader/writer. The reader/writer is provided with an antenna corresponding to the IC tag 10, and performs transmission and reception of radio waves to and from the IC tag 10. The IC tag 10 detects the radio waves from the reader/writer by mean of the three-dimensional antenna formed by the series connection of the coil antennas 22, 24, 26. The three-dimensional antenna is capable of sensing a variation of the magnetic field transmitted as radio waves from the reader/writer by utilizing the principle of electromagnetic induction. In the case where the magnetic field is directed completely in parallel, the electromotive force generated in each coil antenna 22, 24, 26 may be cancelled out depending on the angle of the magnetic field. However, the magnetic field transmitted from the reader/writer in general tends to expand radially, enabling the three-dimensional antenna to sense the magnetic field from all angles.

The received radio waves are sensed as a signal in the IC chip, and based on the signal, the signal processing, such data storage, is performed. A signal based on data such as an identifier, etc. stored in the IC chip is transmitted as required. At the time of transmission, in the IC chip, a signal is converted into radio waves so as to be emitted from the three-dimensional antenna. The emitted radio waves are received by the reader/writer, thereby realizing mutual communication.

Subsequently, a modification of the embodiment is described.

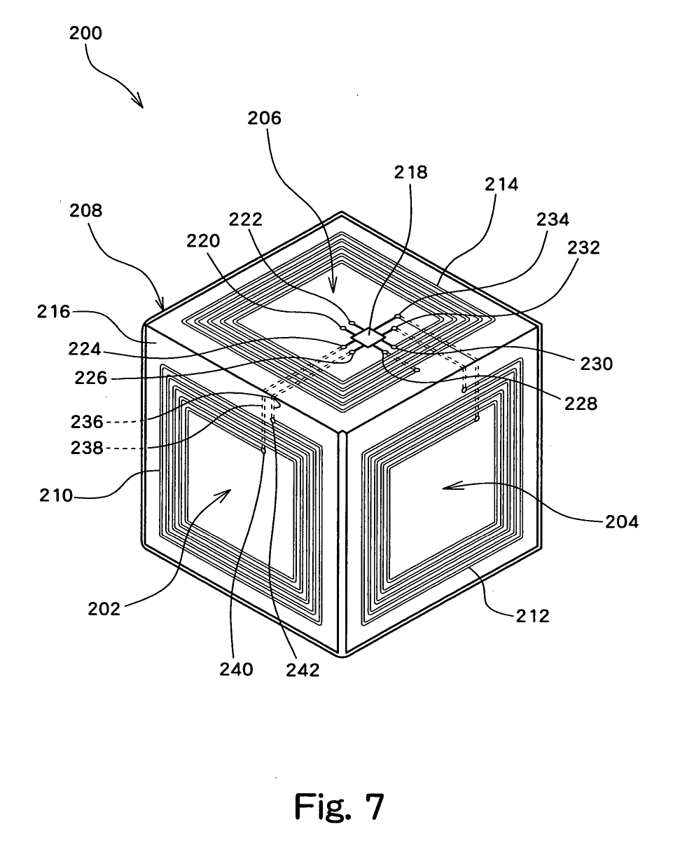

FIG. 7 is a perspective view of an exemplary embodiment of the IC tag according to a modification of the embodiment, viewed from an upper front side. An IC tag 200 shown in FIG. 7 is constituted in almost the same manner as the IC tag 10 shown in FIG. 1. That is, a base 202 is constituted as a base material, the form of which is partially formed by a cube consisting of three surfaces 202, 204, 206 arranged orthogonal to each other. In addition, the construction in which a base film 216 formed with three coil antennas 210, 212, 214 wound counterclockwise in plural turns from the inside to the outside in the figure is adhered to the surfaces 202, 204, 206, is the same as shown in FIG. 1. A main difference is in the wiring between an IC chip 218 mounted on the surface 206 and the coil antennas 210, 212, 214.

The IC chip 218 comprises, as terminals, a pair of battery terminals 220, 222, a pair of antenna terminals 224, 226 corresponding to the coil antenna 210, a pair of antenna terminals 228, 230 corresponding to the coil antenna 214, and a pair of antenna terminals 232, 234 corresponding to the coil antenna 212. That is, the antenna terminal 224 is connected to a terminal 240 inside the coil antenna 210 by a lead wire 238 arranged on the rear side of the base film, and a terminal 242 outside the coil antenna 210 is connected to the antenna terminal 226 by a lead wire 236 arranged on the rear side of the base film. Similarly, the antenna terminals 228, 230 are connected to the terminals outside and inside the coil antenna 214, respectively. The antenna terminals 232, 234 are also connected to the terminals outside and inside the coil antenna 212, respectively. Such wiring enables the three-dimensional antenna consisting of the coil antennas 210, 212, 214 to be an antenna of which each coil antenna 210, 212, 214 is controlled separately and operates independently.

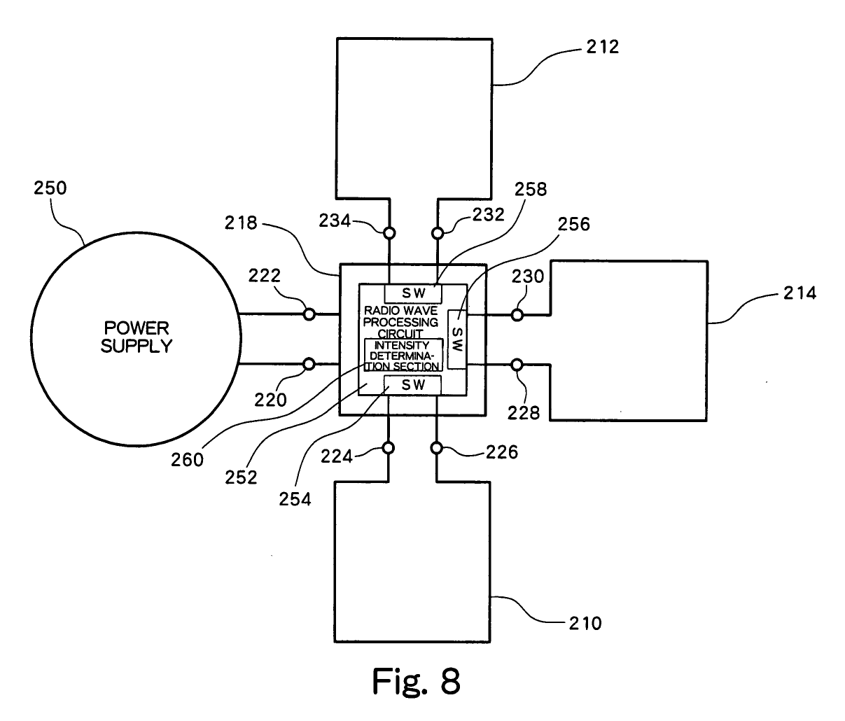

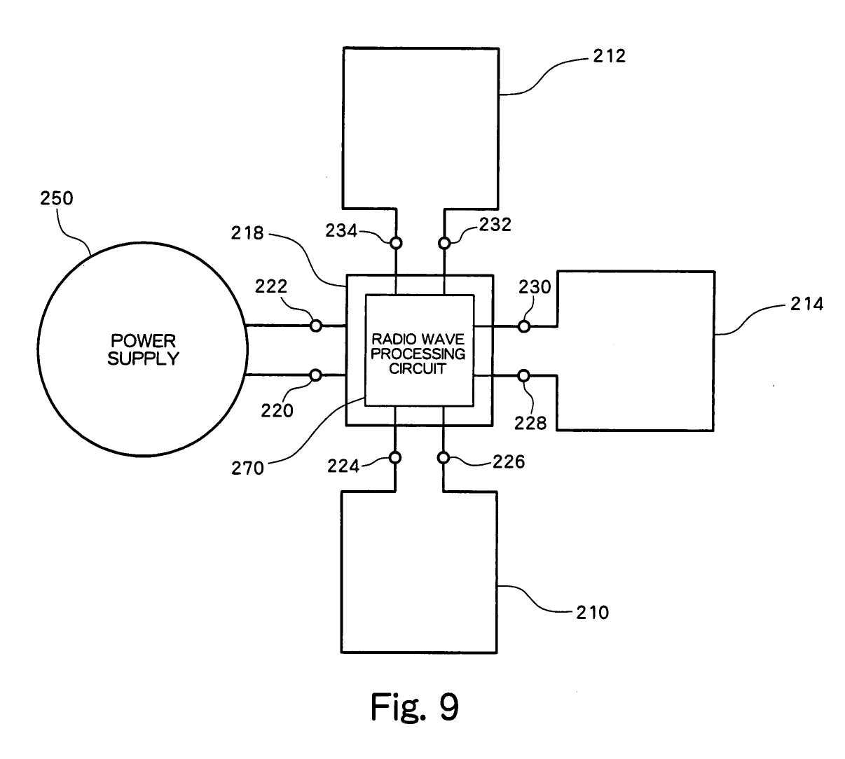

Next, two embodiments of the control of the three-dimensional antenna are described by means of FIG. 8 and FIG. 9, respectively. FIG. 8 is a schematic view of an embodiment for exclusively performing time-division control of each coil antenna 210, 212, 214. In the figure, electric power is supplied from a power supply 250 to the IC chip 218. Also, as shown in FIG. 7, the wiring from the IC chip 218 is provided for each coil antenna 210, 212, 214, respectively.

The IC chip 218 is provided with a radiowave processing circuit 252, connected to each coil antenna 210, 212, 214, for performing communication processing. The connection is effected by switches 254, 256, 258 constituted by switching elements utilizing semiconductors provided in the radio wave processing circuit 252. Each switch 254, 256, 258 is an exclusive switch controlled so as not to be turned on while any of the other switches is turned on. That is, the switches are controlled in such a manner that one of the switches is turned on while the other remaining switches are turned off, or all of the switches are turned off. Further, the radiowave processing circuit 252 is provided with the intensity determination section 260. The intensity determination section 260 compares the intensity of radio waves received from the three coil antennas 210, 212, 214, and determines the coil antenna representing the most preferred reception state.

At start of communication, the switching is performed so as to assign the on-time equally to each switch 254, 256, 258. Then, when the intensity determination section 260 specifies the antenna representing the most preferred reception state, the communication is performed fundamentally by exclusively using the antenna. In order to cope with a variation in the reception state, when the intensity determination section 260 determines that the reception intensity from the antenna has decreased, another switching operation is performed so as to determine the reception intensity of each antenna. Alternatively, the determination of the reception intensity of each antenna may be periodically performed so as to re-determine the antenna to be used. According to the above configuration, the communication can be performed by using a planar antenna representing the most preferred reception state. Since the communication is performed only by using such an antenna, interference with other planar antennas does not occur.

FIG. 9 is a schematic view of an embodiment of control simultaneously using each coil antenna 210, 212, 214. In this example, a radio wave processing circuit 270 provided in the IC chip 218 is different from that shown in FIG. 8, and is not provided with the switches and the intensity determination section. This is because the radio wave processing circuit 270 performs transmission by continuously using each coil antenna 210, 212, 214 at the time of transmission, and performs processing for adding signals from each coil antenna 210, 212, 214 at the time of reception. That is, although each coil antenna 210, 212, 214 functions as an independent antenna, the transmission and reception processing using the antennas are arranged to use the antennas in common. According to the configuration, although there is a possibility of occurrence of interference between each planar antenna, especially at the time of transmission, the sensitivity can be improved by using three planar antennas.

It is also effective to implement a combination of two or three of the three embodiments described above. The combination can be realized by a switch, in accordance with a setting or a reception state, for effecting transfer between at least two of the following embodiments: the embodiment in which planar antennas are connected in series, as described in FIG. 1 to FIG. 6; the embodiment in which independent planar antennas are exclusively switched in the time division manner, as described in FIG. 8; and the embodiment in which independent planar antennas are simultaneously operated, as described in FIG. 9. For example, it is possible to switch over the three embodiments in a short period of time so as to compare the intensity of reception signals, thereby using the embodiment representing the highest reception intensity for effecting the transmission and reception.

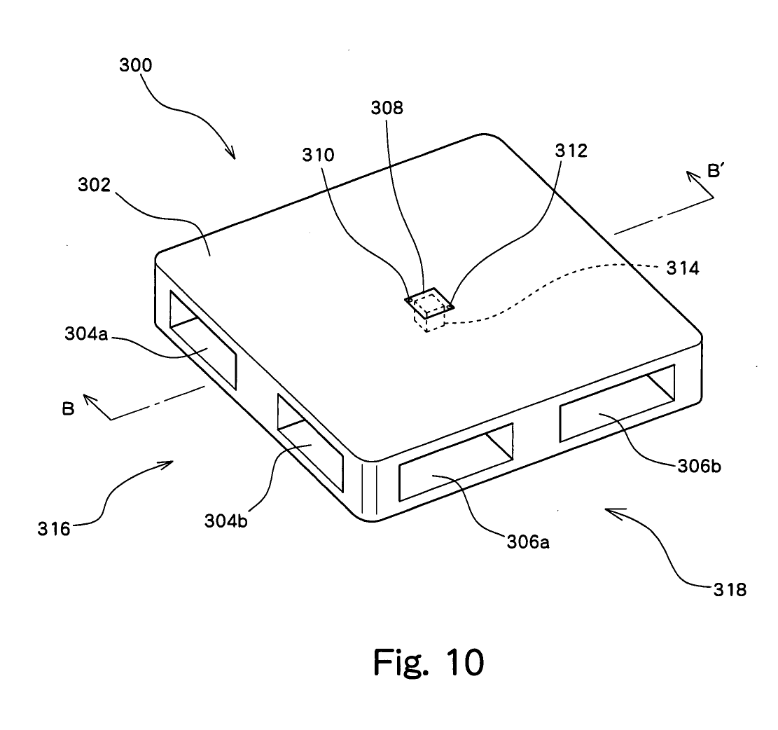

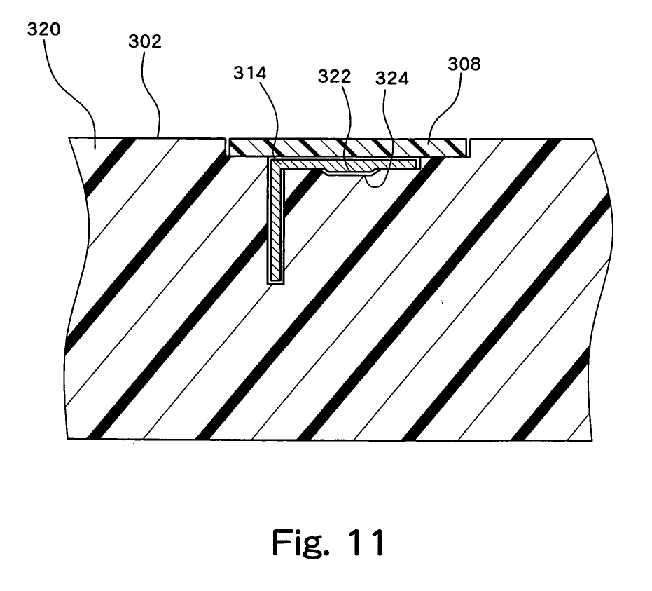

Here, a specific attachment example in the case of attaching the IC tag to a pallet is described using FIG. 10 and FIG. 11.

FIG. 10 is a perspective view of a pallet 300. The pallet 300 is produced by molding a resin (plastic etc.), and has a form made by thinly slicing a cube in the horizontal direction. The size of the pallet is usually specified by various standards, and atypical size of the pallet is about 110 cm×110 cm in the horizontal direction and about ten cm in the thickness direction. The pallet 300 is used for conveying or storing plural packed commodities etc. loaded on its upper surface 302. For this reason, a pair of holes 304a and 304b are provided for the side 316, and a pair of holes 306a and 306b are provided for the side 318, for enabling holding by a forklift.

On the upper surface 302 of the pallet 300, a removable cover 308 is fixed by bolts 310, 312 so as to be within the same plane as the upper surface 302. Inside the cover 308, an IC tag 314 formed by three surfaces orthogonal to each other is provided as shown by the dotted lines.

FIG. 11 is a partial sectional view of the pallet 300 taken along the surface BB′ in FIG. 10. On a resin 320 constituting the main part of the pallet 300, a three-dimensional form is formed for enabling a cover 308 to be fitted in, and the cover 308 is installed therein. In addition, under the cover 308, a three-dimensional form for fitting an IC tag 314 is formed, and the IC tag 314 is attached thereto. On the side of the upper surface 302 of the three-dimensional form, a recessed shape 324 is provided for accommodating a battery attachment part 322 of the IC tag 314 having a swelling shape.

When viewed from the upper surface 302, the three-dimensional form for fitting the IC tag 314 therein is formed to be an L-shape having recessed parts only in the sides of side surfaces 316 and 318, thereby enabling the side of the pallet 300, to which the planar antenna is attached, to be uniquely determined. However, the IC tag 314 may be arranged to be installed to face any side direction of the pallet 300. In this case, the form of the recessed part for fitting provided in the pallet 300 may be formed to be approximately square-shaped when viewed from the upper surface 302.

With this configuration, the IC tag 314 is securely attached to the central part of the pallet 300, thereby enabling stable communication with the reader/writer disposed horizontally in arbitrary relative positions. Further, excellent communication can be achieved by an access from upper and lower directions with respect to the pallet 300 (especially from the lower direction to which the loading is not performed).

Various exemplary embodiments according to the invention are summarized as follows.

In one embodiment of the present invention, each planar antenna is separately connected with an integrated circuit, and the integrated circuit has a switching circuit for switching over the ON and OFF states of each planar antenna, so as to perform transmission or reception of a signal by enabling any one of the planar antennas to be turned on by the switching operation. The switching circuit can be realized by using switching elements etc. employing semiconductors. Each antenna is controlled by the switching circuit so as to enable any one of the antennas to be turned on. In the switching of the planar antennas by the switching circuit, each planar antenna may be treated equally with respect to the time-division time of the ON state and to the switching order of the antennas, or a specified planar antenna may be mainly treated. It is also possible to change the time-division time and the switching order depending on the operating environment, such as to place importance on the use of a planar antenna representing an excellent reception or transmission state. Each planar antenna exclusively performs transmission or reception of the signal of the IC tag for a time period assigned by the switching circuit. As a result, although a restriction is imposed upon the operation time, it is possible to avoid interference due to radio waves generated when each planar antenna is operated simultaneously (especially at the time of transmission). Further, although a restriction is imposed upon the operation time, the disadvantage in transmission and reception based on the directivity of each planar antenna is mutually compensated, as a result of which an excellent transmission and reception environment over a wide angular range can be secured.

In one embodiment of the present invention, the integrated circuit, in accordance with a setting, successively switches over the planar antennas which are turned on by the switching circuit, thereby effecting transmission and reception of the signal. The setting of the switching is predetermined so that each antenna is switched over in turns at the same interval.

In one embodiment of the present invention, the integrated circuit is provided with comparison circuit for comparing the reception intensity of the radio wave from each antenna, so as to enable, by using the switching circuit, the planar antenna having the highest reception radio wave intensity to perform transmission of the signal corresponding to the antenna. That is, the comparison circuit compares the intensity of the radio wave received by each planar antenna from the external reader/writer, so as to specify the planar antenna for which a relative positional relationship with respect to the reader/writer is suitably maintained. For performing transmission in response to the reception (within a short time period, for example, one second), the specified planar antenna is used. As a result, mutual interference of the radio waves can be avoided and the power consumption can also be suppressed, thereby enabling the radio waves with sufficient intensity to be transmitted to the side of the reader/writer. In addition, as a modification, there may be an embodiment in which the reader/writer is arranged to determine the reception intensity of the radio waves from each planar antenna, so as to transfer to the IC tag the determination result on which planar antenna to be used. This embodiment is easily realized, for example, by adding an identification signal to the transmission signal from each planar antenna, for identifying the planar antenna.

In one embodiment of the present invention, at least two planar antennas are connected to the integrated circuit and perform simultaneous emission of the radio waves based on the same signal, or simultaneously transfer the received radio waves to the integrated circuit. This configuration maybe simply implemented with each planar antenna connected in parallel with the input/output terminals of the integrated circuit. However, in order to reduce the effect of the mutual interference, each planar antenna may be connected to the input/output terminals of the integrated circuit which are separately provided. At the time of transmission, the same signal is transferred to each planar antenna which emits radio waves. At the time of reception, each signal received by each planar antenna is simultaneously transferred to the integrated circuit. The plural received signals may be subjected to addition processing, etc. to be converted to a single signal for the discrimination processing, or may be selected based on the intensity etc. to be one signal for the discrimination processing. Each received signal may also be separately subjected to the discrimination processing, and thereafter the processing results may be subjected to redundant processing for collation or the like. In any case, the simultaneous independent operation of each planar antenna enables simultaneous transmission and reception of radio waves in the direction corresponding to the antenna. Although there is a possibility of mutual interference of the radio wave, the excellent transmission and reception of the radio waves over a wide angular range is generally possible.

In one embodiment of the present invention, at least two planar antennas are serially connected so as to function as one antenna as a whole. That is, each one end of each planar antenna is connected so as to form one antenna having a three-dimensional form as a whole. The connection may be implemented, simply by a temporally fixed connection, or by switching control with switching circuit for switching over between the case where each planar antenna operates as one antenna and the case where each planar antenna operates independently. The three-dimensional antenna provided with two or three planar antennas, each functioning independently, makes it possible to constitute an antenna in which the dead angle due to the directivity is reduced.

In one embodiment of the present invention, each of the planar antennas are arranged orthogonally to each other. As a result, the dead angle due to the directivity of each planar antenna is generally compensated, enabling omni-direction coverage. The whole shape of the IC tag may be the cross shape type in the case of two planar antennas, but the L-shape type is useful. This is because this shape facilitates installation of the IC tag in a product and a carrying container having portions of right-angled form in many cases. Similarly, in the case of three planar antennas, the shape of the IC tag can be constituted so as to easily contact with each surface of the 3-dimensionally angled portions in a product and a carrying container.

In one embodiment of the present invention, the integrated circuit is provided within the same surface as any one of the planar antennas. As a result, the IC tag can be made simple in shape and can be easily manufactured and installed.

In one embodiment of the present invention, the IC tag is provided with a base material constituting a three-dimensional form, and each planar antenna is provided on the base material. The base material is made of a material hard enough to maintain by itself the three-dimensional form against its own weight, and can be made of a material having sufficient rigidity to be able to maintain the three-dimensional form when subjected to handling by means of normal human force. For example, a resin provided with an insulation property may be used as the base material. The planar antennas are provided on the surfaces of the base material with the three-dimensional form, the surfaces each having an angle not parallel with respect to each other. The IC tag can be manufactured by attaching planar antennas to the base material which has already been configured as a three-dimensional form. In addition, the base material (especially preferably having flat surfaces) may be attached with planar antennas before being formed into a predetermined three dimensional form, (may also be subjected beforehand to setting for the attachment of the IC chip and the wiring between the IC chip and the planar antennas, as required), and thereafter subjected to bending processing so as to be formed as a three-dimensional form.

In one embodiment of the present invention, each planar antenna is formed directly on the structure of a base material. The direct formation of the planar antenna means that a metal constituting the antenna and the base material are directly joined. For example, the metal is directly joined to the base material by using a winding method, an embedding method, a screen printing method and an etching method, etc. so as to manufacture the IC tag.

In one embodiment of the present invention, each planar antenna is directly formed on a film-like base material, the film-like base material being adhered to a base material. The film-like base material means a thin material which can be easily bent and deformed. Each planar antenna is formed on a separate film-like base material, or on a separate same film-like base material by means of screen printing and etching, etc. The film-like base material is then adhered to a suitable part of the base material, enabling the IC tag to be configured. In addition, the connection of the planar antennas with the integrated circuit may be effected before or after the adhesion of the film-like base material to the base material. The IC chip as the integrated circuit may be fixed to the film base material, or directly to the base material.

In one embodiment of the present invention, the three-dimensional form of the base material is a cylindrical or polygonal columnar form, so that each planar antenna is provided on the surface constituting the side surface of the cylindrical or polygonal columnar form. As a result, the three-dimensional configuration of the IC tag can be simplified.

In one embodiment of the present invention, the UHF band is used as the transmission and reception frequency of the radio wave. The UHF band includes radio waves with a frequency of about 300 MHz to 3 GHz. In the IC tag of the UHF band, the communicable distance between the IC tag and the reader/writer is relatively long. As a result, there is a tendency to require not only the capability of communication with the reader/write arranged in a specified close position, but also the capability of communication with the reader/writer arranged in a relatively distant position and having unspecified angles. Thus, the invention can be used in the IC tag of the UHF band. However, the UHF frequency ranges (authorized or to be authorized for utilization) available at present, are 950 to 956 MHz in Japan, 920 to 928 MHz in the United States and Canada, and 867 to 869 MHz in the EU and Singapore. It goes without saying that the same technical implementation is possible for a radio waves other than the above-mentioned examples of the UHF bands.

The pallet according to the invention is a pallet used as a deck at the time of storing or carrying an article and is provided with the above-described IC tag. The pallet is a deck used in carrying an article by a forklift. An article is loaded on the pallet so as to be moved to a predetermined place, thereby enabling the storage and the conveyance of the article. The direction of the pallet at the time of conveyance and storage is not fixed, so that the positional relationship between the IC tag attached to the pallet and the reader/writer tends to be uncertain. Here, there is an advantage of attaching to the pallet the above-described IC tag capable of performing excellent transmission and reception over a wide angular range. This is because the IC tag is capable of securing a sufficient communication function, when attached at any angle with respect to the pallet. It is also useful that the pallet is configured as a three-dimensional form and made of a plastic used as a carrier container, and that the IC tag is installed by arranging each planar antenna on each of the two or three plastic surfaces of the pallet which are not parallel to each other. That is, the pallet and the IC tag are fixed in contact with each other at a place where the three-dimensional form of the pallet is similar to that of the IC tag. As a result, the stability and the difficulty for detachment can be improved. Also, the pallet made of a plastic provides an advantage for facilitating attachment of the IC tag, and for causing hardly any problem in transmission and reception of radio waves.

While the preferred embodiments of the present invention have been described using specific terms, such description is for illustrative purposes only, and it is to be understood that changes and variations may be made without departing from the spirit or scope of the appended claims.

The disclosure of Japanese Patent Application No. 2004-134139 filed on Apr. 28, 2004 including specification, claims, drawings and abstract is incorporated herein by reference in its entirety.

1. An IC tag comprising: a three-dimensional antenna formed by a plurality of planar antennas, each of which is capable of performing emission and reception of radio waves by itself, and which are arranged to be not parallel to each other; and an integrated circuit connected to the three-dimensional antenna, for performing transmission and reception of a signal by way of the three-dimensional antenna.

2. The IC tag according to claim 1, wherein each planar antenna is separately connected to the integrated circuit, and wherein the integrated circuit comprises a switching circuit for switching over the ON and OFF states of each planar antenna so as to enable any one of the planar antenna to be turned on, thereby performing transmission or reception of a signal.

3. The IC tag according to claim 2, wherein the integrated circuit, in accordance with a setting, successively switches over the planar antennas which is turned on by the switching circuit, thereby performing transmission or reception of a signal.

4. The IC tag according to claim 2, wherein the integrated circuit comprises a comparison circuit for comparing the reception intensity of the radio waves received by each planar antenna, and wherein the switching circuit is used to perform, from the planar antenna representing the highest intensity of the received radio waves, transmission of the signal corresponding to the antenna.

5. The IC tag according to claim 1, wherein at least two planar antennas are connected to the integrated circuit respectively, the planar antennas performing emission of the radio waves simultaneously based on the same signal, or performing transmission of the received radio waves simultaneously to the integrated circuit.

6. The IC tag according to claim 1, wherein at least two planar antennas are connected in series so as to function as a single antenna as a whole.

7. The IC tag according to claim 1, wherein each planar antenna is arranged orthogonal to each other.

8. The IC tag according to claim 1, wherein the integrated circuit is provided with in the same surface as anyone of the planar antennas.

9. The IC tag according to claim 1, further comprising a three-dimensional base material on which each planar antenna is provided.

10. The IC tag according to claim 9, wherein each planar antenna is formed directly on the base material.

11. The IC tag according to claim 9, wherein each planar antenna is formed directly on a film-like base material which is adhered to the base material.

12. The IC tag according to claim 9, wherein the three-dimensional form of the base material is a cylindrical form or a polygonal columnar form and each planar antenna is provided on a surface constituting the side surface of the cylindrical form or the polygonal columnar form.

13. The IC tag according to claim 1, wherein a UHF band is used as a transmission and reception frequency of the radio wave.

14. A pallet for use in storing or carrying an article, comprising the IC tag according to claim 1.

15. A method for fabricating an IC tag, comprising:
forming a three-dimensional antenna by arranging a plurality of planar antennas to be not parallel to each other, each of the planar antennas being capable of performing emission and reception of radio waves by itself; and
connecting the three-dimensional antenna to an integrated circuit; wherein
the IC tag performs transmission and reception of a signal by way of the three-dimensional antenna.

16. The IC tag fabrication method according to claim 15, wherein
the connecting step includes separately connecting each of the planar antennas to the integrated circuit by providing a switching circuit for switching over the ON and OFF states of each planar antenna.

17. The IC tag fabrication method according to claim 15, wherein
the connecting step includes connecting at least two planar antennas to the integrated circuit respectively, thereby enabling the planar antennas to perform emission of radio waves simultaneously based on the same signal or to perform transmission of received radio waves simultaneously to the integrated circuit.

18. A communication method employing an IC tag, comprising:
performing emission or reception of radio waves using a three-dimensional antenna formed by arranging a plurality of planar antennas to be not parallel to each other, each of the planar antennas being capable of performing emission and reception of radio waves by itself; and
performing transmission or reception of a signal, via the three-dimensional antenna, using an integrated circuit connected to the three-dimensional antenna.

19. The IC tag communication method according to claim 18, wherein
in the step of performing signal transmission or reception, the integrated circuit switches over the ON and OFF states of each planar antenna so as to turn on any one of the planar antennas to perform signal transmission or reception.

20. The IC tag communication method according to claim 18, wherein
in the step of radio wave emission or reception, at least two planar antennas perform emission of radio waves simultaneously based on the same signal, or perform transmission of the received radio waves simultaneously to the integrated circuit.
